(19) United States
(12) Patent Application Publication
(10) Pub. No.: US 2016/0285957 A1
(43) Pub. Date: Sep. 29, 2016

(54) SERVER CLUSTER PROFILE DEFINITION IN A DISTRIBUTED PROCESSING NETWORK

(71) Applicant: Avaya Inc., Santa Clara, CA (US)

(72) Inventors: Kurt Haserodt, Westminster, CO (US); William T. Walker, Evergreen, CO (US); Benny Ellis, Denver, CO (US)

(21) Appl. No.: 14/670,296

(22) Filed: Mar. 26, 2015

(51) Int. Cl. H04L 29/08

(52) U.S. Cl. CPC H04L 67/10

(57) ABSTRACT

A computational system including first and second clusters of servers, the first cluster corresponding to a first set of cluster attributes and the second cluster to a second set of cluster attributes, the first set of cluster attributes defining a common set of attributes for each member server of the first cluster and the second set of cluster attributes defining a common set of attributes for each member server of the second cluster, wherein the first and second sets of cluster attributes are different.

### FIELD

The disclosure relates generally to unified communications and particularly to configuring clusters of servers in a telecommunications system.

### BACKGROUND

A contact center (also referred to as a customer interaction center or e-contact center) is a central point in an enterprise from which all customer contacts, such as voice calls, faxes, social media, instant messages, and email, are serviced by contact center resources, such as automated response units (e.g., an Interactive Voice Response systems or IVR's) or human agents. An inbound contact center is operated by the enterprise to administer inbound contacts from customers or potential customers regarding the products or services offered by the enterprise. Outbound contact centers are operated for telemarketing, such as solicitation of charitable or political donations, debt collection and market research.

Avaya Aura™ and Engagement Development Platform™ are voice portal platforms that can provide simple touch tone and voice responses to intelligent routing of contacts and automation with multimedia inbound and outbound communications. Voice portal platforms enable organizations to take advantage of the Session Initiation Protocol or (“SIP”). As a set of logical connections over an existing IP connection, SIP does not require fixed pre-allocated circuits, thereby freeing the contact center from the costs and constraints of physical Time Division Multiplexed (“TDM”) circuits.

Voice portal platforms can use a cluster or group of servers that work together as a single system. Clusters can provide fault resilience over single systems and support scaling by adding more nodes or elements (e.g., servers) to the cluster. In the event of a system failure, clustering can preserve data and ensure resource availability to end users.

Engagement Development Platform™ employed one cluster in which every member server had the same set of applications running. All of the member servers were managed as a common group regardless of the number of servers in the cluster. While providing fault resistance and scalability, the limitation of one cluster could sacrifice flexibility in certain applications.

There is a need for a general purpose application platform that can configure and define multiple server clusters.

### SUMMARY

These and other needs are addressed by the various aspects, embodiments, and/or configurations of the present disclosure. The present disclosure can provide a mechanism and system for heterogeneous clusters of a general purpose application platform that delivers cluster definitions such that the different sets of applications and associated configurations for each cluster are effectively attributes.

A system can include first and second clusters of servers. The first cluster corresponds to a first set of cluster attributes, and the second cluster to a second set of cluster attributes. The first set of cluster attributes define a common set of attributes for each member server of the first cluster, and the second set of cluster attributes define a common set of attributes for each member server of the second cluster. The first and second sets of cluster attributes are different.

A method can include the steps:

(a) selecting a first cluster object;

(b) assigning an identifier to the first cluster object;

(c) associating the first cluster object with at least one of a cluster profile type and set of attributes; and

(d) assigning a plurality of servers to the first cluster object to form a first cluster of servers.

When the first cluster profile is compared to a second cluster profile for a second cluster of servers, one or more of the following is true: (i) the attributes of the first cluster is different from the attributes of the second cluster and (ii) the servers in the first and second clusters are disjoint sets.

In one application, the disclosure can provide for heterogeneous clusters of a general purpose application platform that deliver cluster definitions such that the different sets of applications and associated configurations for each cluster are effectively attributes. A cluster can be defined by many different attributes, including without limitation cluster type and version, cluster server minimum version, minimum and maximum number of cluster servers, minimum cluster server resource specification (e.g., memory, disk, CPUs, etc.), required applications (e.g., snap-in services) and minimum versions, optional applications and minimum versions, whether or not additional applications beyond the listed and optional applications can be installed (e.g., whether the cluster is “open” (or any application permitted) or “closed” (or blocked from installing non-listed applications)), data grid type and configuration, (HTTP) load balancer enablement and configuration, disk allocations, memory allocations, open ports, port ranges, and rate limits. Regarding open and closed clusters, application restrictions or lack thereof can be provided for multiple machines at a cluster level rather than a server level and is differentiated from other approaches by how it is configured and distributed. There can be an ability to modify even closed clusters and the delivery mechanism can make changes for open and closed clusters. Each attribute in the cluster profile includes metadata identifying whether the attribute is visible on the administration user interface, and, if so, whether or not it is editable by the administrator. These attributes can be controlled in a template called a cluster profile.

A cluster profile is selected by the administrator whenever a new cluster is created to pre-configure the cluster for the intended use. Any required applications identified in the cluster profile can be automatically installed without requiring user action.

Some cluster profiles can be included with a management application. For example, the management application can include a general purpose cluster profile that third party application developers can use to support their applications. Other cluster profiles that are unique to a given product application can be delivered in a single product pack or package along with the product snap-in software. This can enable a product to be largely turnkey, such that loading the product pack and creating a cluster with the product's cluster profile will automatically configure the cluster for the product and install the product snap-ins. With this approach, a general purpose application platform can be configured readily to support specific product needs for a given cluster.

As will be appreciated, the management application can allow or enable an administrator to create his or her own cluster profiles based on the needs for the administrator's enterprise. This ability can provide enhanced flexibility and configurability for the administrator to meet the unique needs and requirements of the enterprise.

The present disclosure can provide a number of advantages depending on the particular aspect, embodiment, and/or configuration. The present disclosure can provide a general purpose application platform able to configure and define multiple server clusters, each with its own cluster attributes and installed applications (e.g., snap-in services). Cluster attributes can be configured via cluster profiles to allow for greater flexibility in the use of a general purpose application platform. This can allow server clusters for product applications with specific cluster resource and/or configuration needs. Heterogeneous clusters can enable more flexible deployment strategies and higher levels of scalability and availability of the application platform. Clustering offers the ability to manage the capacities of space for logging, memory usage, and CPU usage. The capacities can be engineered by the cluster profile creator and set in the cluster profile attributes.

These and other advantages will be apparent from the disclosure.

An “application” or “software application” is a program, or group of programs, or software module that is designed for an end user. Application software can generally be divided into two general classes: systems software and applications software. Application software (also called end-user programs) includes such things as database programs, word processors, Web browsers and spreadsheets.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

The term “computer-readable medium” as used herein refers to any storage and/or transmission medium that participate in providing instructions to a processor for execution. Such a computer-readable medium is commonly tangible and non-transient and can take many forms, including but not limited to, non-volatile media, volatile media, and transmission media and includes without limitation random access memory (“RAM”), read only memory (“ROM”), and the like. Non-volatile media includes, for example, NVRAM, or magnetic or optical disks. Volatile media includes dynamic memory, such as main memory. Common forms of computer-readable media include, for example, a floppy disk (including without limitation a Bernoulli cartridge, ZIP drive, and JAZ drive), a flexible disk, hard disk, magnetic tape or cassettes, or any other magnetic medium, magneto-optical medium, a digital video disk (such as CD-ROM), any other optical medium, punch cards, paper tape, any other physical medium with patterns of holes, a RAM, a PROM, and EPROM, a FLASH-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored. Computer-readable storage medium commonly excludes transient storage media, particularly electrical, magnetic, electromagnetic, optical, magneto-optical signals.

The terms “determine”, “calculate” and “compute,” and variations thereof, as used herein, are used interchangeably and include any type of methodology, process, mathematical operation or technique.

An “installable software module” refers to a software module that can be installed into a computational system and function as part of the system and/or other software on the system. The function can be through an application programming interface. A “snap-in” is a type of installable software module, such as a helper software application, that deploys into a computational platform and, while similar to a browser plugin, can be in a network core.

The term “means” as used herein shall be given its broadest possible interpretation in accordance with 35 U.S.C., Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

The term “module” as used herein refers to any known or later developed hardware, software, firmware, artificial intelligence, fuzzy logic, or combination of hardware and software that is capable of performing the functionality associated with that element.

A “service” refers to an application that performs a set of functions or operations, such as a snap-in, plug-in, and the like.

The preceding is a simplified summary of the disclosure to provide an understanding of some aspects of the disclosure. This summary is neither an extensive nor exhaustive overview of the disclosure and its various aspects, embodiments, and/or configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and/or configurations of the disclosure are possible utilizing, alone or in combination, one or more of the features set forth above or described in detail below. Also, while the disclosure is presented in terms of exemplary embodiments, it should be appreciated that individual aspects of the disclosure can be separately claimed.

### BRIEF DESCRIPTION OF THE DRAWINGS

FIG. 1 is a block diagram of a voice portal platform according to an embodiment;

FIG. 2 is a block diagram of a cluster according to an embodiment;

FIG. 3 depicts data structures according to an embodiment; and

FIG. 4 is a flow chart according to an embodiment.

### DETAILED DESCRIPTION

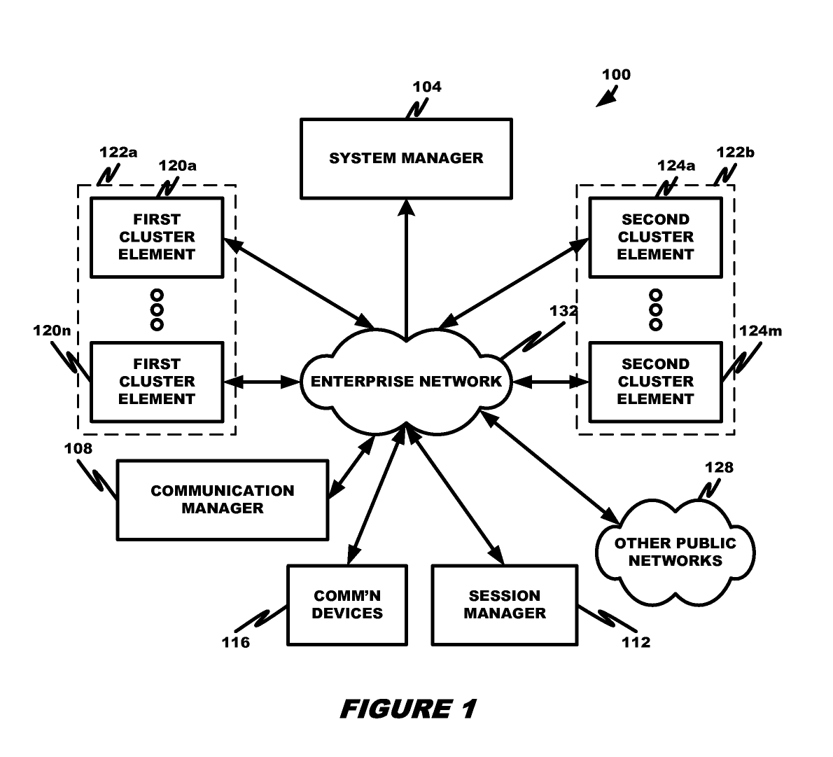

With reference to FIG. 1, the voice portal platform 100 includes a system manager 104, communication manager 108, session manager 112, communication devices 116, first cluster 122a comprising first cluster elements 120a-n and second cluster 122b comprising second elements 124 a-m, and other public networks 128, all interconnected by an enterprise network 132.

Although the present disclosure is discussed with reference to a voice portal platform, it is to be appreciated that the cluster definitions or profiles and configurations disclosed herein can be applied to any general purpose application platform and can host many different kinds of collaboration applications beyond voice portals. Moreover, though the present disclosure is discussed with reference to only two clusters, it is to be appreciated that the concepts disclosed herein can be applied to any number of clusters.

The system manager 104 can be any hardware/software providing a central management system that delivers a set of shared management services (e.g., provisioning and serviceability) and provides a common console for applications and systems. The common console is a common management interface for managing various applications in the system manager 104. The common console is primarily a framework for the aggregation of management presentation views. The common console framework supports dynamic extendibility and contraction as management applications can be added or removed.

The communication manager 108 can be any hardware/software providing an IP telephony foundation to provide unified communications for the enterprise. It can deliver rich voice and video capabilities and provide for a resilient, distributed network of gateways and analog, digital and IP-based communication devices. It can include advanced mobility features, built-in conference calling and contact center applications, and E911 capabilities.

The session manager 112 can be any hardware/software that can support routing and/or handling of SIP messages and registration and perform as a media request broker for media server selection. The session manager can be, for example, a router, a server, a Private Branch Exchange (PBX), a proxy server, a gateway, a network switch, a communication system, various combinations of these, and the like. The session manager 112 is shown as a single entity. However, the session manager 112 may comprise any number of session managers and/or a variety of components and be distributed within a network or across multiple networks.

The session manager 112 can include any switch or server that is capable of controlling signaling flows for one or multiple users in a communication network. It may be authoritative for certain user groups within a communication network or may be configured to handle communication sessions for any user in the communication network. It can assist two or more internal or internal and external communication devices exchange messages for the purposes of negotiating and establishing a media path directly between the communication devices.

The first and second clusters 122a-b each provides a set of services or applications to other components of the voice portal platform 100. Each of the first and second clusters 122a and 122b have a common set of cluster definitions for its member cluster elements (e.g., servers), but the first and second clusters 122a-b have different sets of cluster definitions when compared to each other. Stated another way, the cluster profiles and attribute definitions for different clusters 122 can be heterogeneous (or different) while the member element profiles and attribute definitions within a selected cluster 122 are homogeneous (or identical) because the descriptions in the cluster profile (e.g., attribute definitions) apply to every member cluster element of the corresponding cluster 122. For example, while different clusters 122a-b can have different sets of software modules installed on their respective set of member cluster elements, each member cluster element of the corresponding cluster has the same software modules installed. The member cluster elements of a cluster 122 are normally co-located physically to avoid latency and other performance issues. Each cluster 122 typically has a unique (fully qualified) domain name (e.g., IP address) common to all of its member cluster elements. As discussed below, each cluster definition has different sets of applications and associated configurations that are effectively attributes.

The system manager 104, communication manager 108, session manager 112 and first and second clusters 122a-b, respectively, can be implemented on any computational system, including without limitation Avaya Inc.'s S8800™, S8510™, and S8300™ servers interconnected with one or more of the following media gateways of Avaya, Inc.: G650™, G250™, G350™, G450™, IG550™, G700™, G650™, CMC1™, SCC1™, and MCC1™ media gateways.

The communication devices 116 may be any device that can communicate with session manager 112, such as a Personal Computer (PC), a telephone, a video system, a cellular telephone, a Personal Digital Assistant (PDA), a tablet device, a notebook device, a server, a router, and/or the like. Although FIG. 1 shows only generic communication devices 116, the voice portal platform 100 can include any number of communication devices 116. The communication devices 116 may use a variety of protocols, such as Ethernet, Internet Protocol (IP), Session Initiation Protocol (SIP), Voice over IP (VoIP) network, Integrated Services Digital Network (ISDN), and the like.

The other public networks 128 and enterprise network 132 can be any network, such as the Internet, a Wide Area Network (WAN), a Local Area Network (LAN), the Public Switched Telephone Network (PSTN), a packet-switched network, a circuit-switched network, a cellular network, and/or a combination thereof. In one application, the other public networks 128 include the Internet, and the enterprise network 132 is a trusted or private network, such as a Local Area Network (LAN).

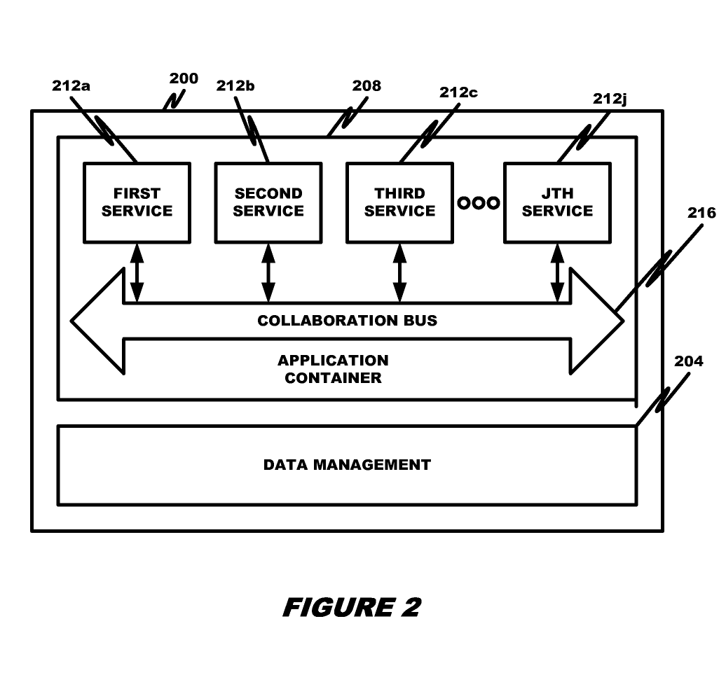

FIG. 2 shows a typical cluster element 200, or server. A cluster 122 includes a plurality of cluster elements 200 or servers. A cluster element can be a single virtual machine, such as a process virtual machine (or application virtual machine or managed runtime environment), with the surround components and a JEE container running on it. The cluster element 200 can include data management 204, such as a data grid (e.g., a replicated in-memory data cache used to store runtime and semi-persistent data and share data across cluster elements), to allow services or applications to store data and have it be accessible to other elements in the cluster and an application container 208. The application container 208 includes first, second, third, . . . jth services (or applications) 212a-j connected by a collaboration bus 216. As will be appreciated, a cluster element is not limited to the particular configuration shown in FIG. 2 but can apply to any processing module capable of providing multiple services.

The services (or applications) 212a-j can be any collaboration application providing one or more services. For example, a service may provide an enhanced caller ID service, recording service, call blocking service, call routing service, mid-call announcement service, service watchdog service (e.g., process life cycle, monitoring and recovery), access to components service (e.g., secure access to servicing and debugging tools), serviceability agent and netSNMP (e.g., generating alarms and Simple Network Management Protocol (“SNMP”) traps), provisioning database service (e.g., provisioned data access), management agent service (serviceability monitoring, maintenance tests, service deployment, and/or data replication and change notification), data grid cluster manager and/or gigaspaces manager, platform application (e.g., SIP options monitoring response (allows clients to proactively know state of server's SIP service), SIP header reduction (for sequenced services), and/or SIP outgoing routing), custom application router service (e.g., SIP internal application selection and sequencing)), data access application programming interface (“API”) (via data access objects—DAOs) (e.g., data access, abstraction, caching, and/or notification), logging AP service (e.g., logging events to various log files), eventing framework service (e.g., subscriptions are stored to the data grid so that the consumers of events can be notified regardless of the cluster object instance on which the event was raised), SIP sequenced service (e.g., various call processing and/or routing functions, such as for call origination and termination with a sequenced service being referred to herein as “call intercept service”, origination sequenced services as “calling party services”, and termination sequenced services as “called party services”), SIP named service (e.g., various terminating call processing functions), SIP virtual endpoint service (e.g., various originating and terminating call processing functions), HTTP named application service (e.g., converged SIP and HTTP communications), a proxy application service, a Back-to-Back User Agent (B2BUA), a named application service (e.g., a Hunt group), gateway service (e.g., the service looks to the session manager 112 like a SIP trunk gateway, with the difference being that the endpoints on the other side of the gateway are browsers on the Internet rather than phones on the PSTN), context store (e.g., which provides a store of information related to a customer interaction in a contact center), workflow engine (e.g., which provides a way for non-developers to create scripts that can utilize rich communication capabilities), unified speech service (e.g., which provides real-time speech query capabilities to determine if one or more of the parties to a call is speaking certain key phrases), a WebRTC gateway service (e.g., which enables web applications to embed communication functionality into a user experience), a work assignment engine (e.g., which assigns agents to customer contacts over multiple media types), performance center service (e.g., which provides contact center reporting and performance analytics), presence service, unified agent desktop service (e.g., which enables a browser-based agent (subscriber) communication device to monitor and control other subscriber communication devices), call event/control service (e.g., which generates asynchronous call events that other services can subscribe to in order to be apprised of call activity for various users and can enable a service that was not sequenced in a call to operate on that call, such as to request call and media services, e.g., forking a call, playing an announcement, etc.), and the like.

The collaboration bus 216 provides both point-to-point and publish/subscribe channels and can allow other services to access capabilities, such as email, short message service, and scheduled conference application programming interfaces and conference connectors. Services can use the collaboration bus to request another service to act or subscribe to messages published by other services. An eventing framework can ride atop the collaboration bus to allow for services to dynamically subscribe for events and specify fine-grained features.

Generally, A cluster profile is associated with a cluster and includes cluster profile name and/or identifier (e.g. “Data Center 1 Cluster”), configuration information, attribute definitions, requirements, and rules of operation for the associated cluster. A product can define, by cluster profile name and/or identifier, a corresponding cluster profile to align with its deployment needs. The identified cluster profile name and/or identifier defines the cluster type to be employed. All clusters with the same cluster profile name and/or identifier have the same configuration. Stated differently, a plurality of predetermined cluster profile types are provided by the manufacturer or vendor, which, when identified or referenced by the cluster profile name and/or identifier, define the cluster type to be employed. A first cluster profile name and/or identifier is used to define a cluster as a first cluster type, a second cluster profile name and/or identifier is used to define a cluster as a second cluster type, and so on. Clusters can also define a data grid that spans all cluster elements in the cluster. Installable software modules (e.g., a snap-ins) can then deploy spaces onto the grid that share data amongst all of the cluster elements.

The cluster profile can include a set of attributes that define the requirements and rules for the cluster. The elements in a selected cluster are managed as a group and independently from member elements in other clusters. Installable software modules stipulated by the attributes can be loaded and installed for each cluster, thereby causing all cluster elements in a selected cluster to have a common set of installable software modules. The data grid can be set up for the common cluster based on the cluster attributes.

The cluster profile can be predetermined or default and non-editable, configurable by the user, or a combination thereof. An example of the former is a product pack, or set of manufacturer or vendor specified services. A product pack can be a set of applications, applets, servlets, application programming interfaces, and other software components and configuration information, such as predetermined cluster profiles, to run a corresponding product. In one application, the product pack includes the cluster profile and service archives for the snap-ins to be installed. The service archives include, for example, the service, including the attribute descriptors, runtime binaries that are deployed and/or executed on the cluster element, user portal portlet, and the like. An example of a user configurable cluster profile is one that can be modified by a system administrator of an associated enterprise to define one or more cluster profiles to suit the needs of the enterprise and the applications it uses.

As noted, the cluster can define a data grid that can be used by the installable software module installed on the cluster. The data grid is shared by all cluster element nodes in the cluster. The attributes for the grid can be defined in the cluster profile. The grid will be created and configured when cluster elements are added to the cluster. For high availability, two of the cluster elements can be designated to run the lookup services by the cluster element manager. A data grid application programming interface can be provided for installable software modules to create and access processing units or PUs and spaces. A processing unit container is a component implemented by the user and deployed and managed by a service grid. The data grid application programming interface can also provide access to use simple name/value pair PUs.

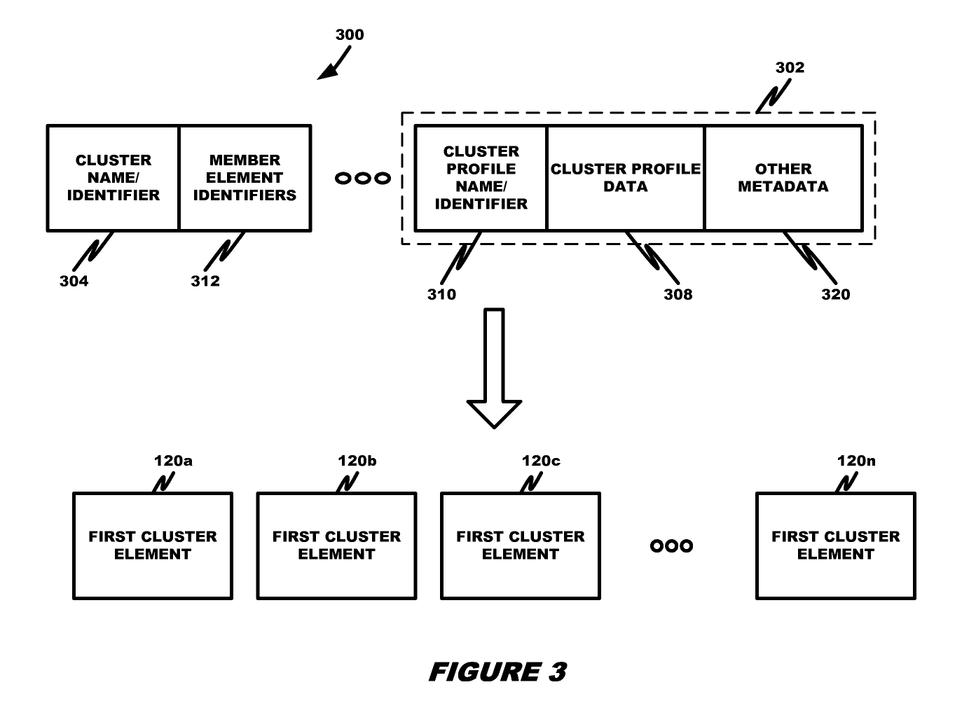

An example of a cluster definition associated with a plurality of cluster elements 120 will now be described with respect to FIG. 3. As shown a cluster definition 300 includes data structures including the cluster name and/or identifier 304, the member element identifiers 312, and the cluster profile 302, corresponding to the cluster defined by the cluster profile name and/or identifier 310. The cluster profile data structures 302 include not only the cluster profile name and/or identifier 310 but also cluster profile data 308, and other metadata 320.

The cluster name and/or identifier 304 is user configurable and refers to an identifier 304, such as a name (e.g. “Data Center 1 Cluster”), electronic address (e.g., IP or MAC address), link to a corresponding set of cluster elements, or other unique identifier associated with the corresponding cluster. The cluster name/identifier 304 is not in the cluster profile 302, unique to each cluster, and assigned by the administrator when the corresponding cluster is created.

Member element identifiers 312 refer to identifiers for each member element in the cluster. The identifiers can be any unique identifier of the corresponding member element. For example, the element identifiers can be an electronic address (e.g., an IP address, a MAC address, or other network address, an address in memory, etc.) associated with the corresponding element, a link such as a hyperlink referencing the corresponding element, a name of the corresponding element, a memory address for the corresponding element, a pointer to the corresponding element, a hash tag associated with any of the foregoing, and the like. The member element identifiers 312 are not in the cluster profile 302, unique to each cluster, and assigned by the administrator when the corresponding cluster is created.

The cluster profile data 308 can be of many attribute types. Examples include ClusterTypeVersion (or the version of the cluster type or profile), MinNodes (or the minimum number of cluster elements requirements in a cluster), MaxNodes (or the maximum number of cluster elements allowed in a cluster), ReqCPUs (or the minimum number of required virtual Central Processing Units (“CPUs”) per element), ReqRAM (or the minimum amount of RAM required (GB) per element), ReqDisk (or the minimum amount of disk space required (GB) per element), BWAvail (or the bandwidth available), MaxLogCap (or the maximum logging capacity for all installable software modules (GB)), MaxMemCap (or the maximum memory capacity for all installable software modules (GB)), AllowOtherSnaps (or whether to permit any application (or “open) or block from installing non-listed applications (or “closed”), ReqSnaps (or the list of required installable software modules including version), OptionalSnaps (or the list of optional installable software modules including version), SvarTypesAllowed (or the list of service archive (“svar”) (or the bundle that comprises a service, including attribute descriptors, runtime binaries that are deployed/executed on the cluster element server, a user portal portlet, etc.) types allowed), ReplicationPollInterval (or the replication poll interval (seconds)), ReplicationGroup (determines the set of tables to replicate), GridRequired (whether or not the cluster requires a grid), GridType (or the type of grid to be employed), GridSecure (or whether a password or other credentials are needed to access the grid), GridPassword (or the password or other credentials needed to access the grid), GridMem (or the grid memory (e.g., heap) configuration (GB) per Giga Space Container (“GSC”)), GridGSCs (or the GSCs per element), GridMemUntouchable (or the amount of memory on the cluster element that the grid cannot use per the cluster element), GridGSCJavaOptions (additional Java options passed used by the data grid container manager (“DCM”)), PortsToOpen (or the ports to open), LoadBalanceMethod (or what load balancing method is to be used for the cluster), CalllnterceptMethod (or how the cluster is to handle call intercepts), SessionRefreshInterval (or the session refresh interval (seconds)), ReplicationType (or what type of replication is to be used), and MinimumPlatformVersion (or the minimum node platform version required).

Cluster profile data 308 can further include service and/or application identifiers of each service and/or application associated with the corresponding cluster. The identifiers can be any unique identifier of the corresponding service and/or application. For example, the element identifiers can be an electronic address (e.g., an IP address, a MAC address, or other network address, an address in memory, etc.) associated with the corresponding service and/or application, a link such as a hyperlink referencing the corresponding service and/or application, a name of the corresponding service and/or application, a memory address for the corresponding service and/or application, a pointer to the corresponding service and/or application, a hash tag associated with any of the foregoing, and the like. While in closed clusters, all services are defined in cluster profile, in open clusters there may be services installed on the cluster that are not part of the cluster profile 302 but are included in the cluster definition 300. Such services are not shown in the cluster definition 300.

Other metadata 320 includes metadata associated with one or more attributes identified in cluster attributes 304. Each attribute can include metadata defined in the cluster profile, including whether or not the corresponding attribute is to be specified or is required (Yes (or required)/No (or optional) Boolean value), whether or not the corresponding attribute is viewable in the session manager graphical user interface (Yes (or is viewable)/No (or is not viewable) Boolean value), whether or not the corresponding attribute is service affecting (Yes (or is service affecting)/No (or is not service affecting) Boolean value), whether the corresponding attribute is fixed or can be changed for the cluster (each cluster could then have its own or a different value for the attribute) (Yes (attribute is fixed)/No (attribute can be changed or edited) Boolean value), a description for the corresponding attribute, help information for the corresponding attribute, the type of the corresponding attribute (e.g., expressed as one or more of an integer, range, string, Boolean, list, date, ip, json, xml, or enum), choices for the corresponding attribute (e.g., for the enums), whether or not the corresponding attribute definition/description is to be encrypted (Yes (encryption required)/No (encryption is not required) Boolean value), whether or not the services in the cluster are closed and cannot be changed or otherwise edited or open and can be changed, edited, removed, or added to (Yes (open)/No(closed), a default value for the corresponding attribute, and cluster profile description.

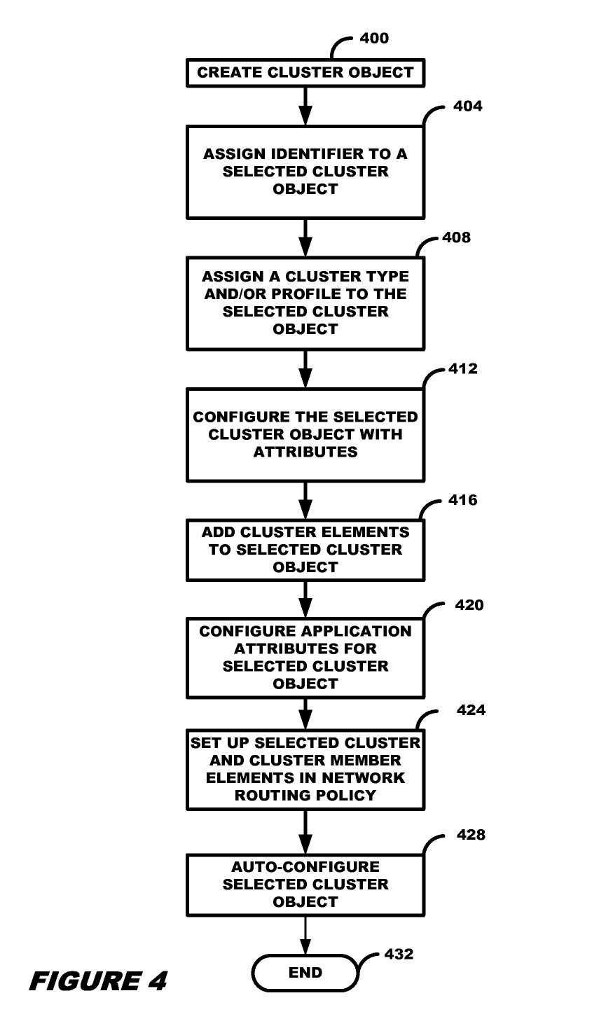

A provisioning method will now be discussed with reference to FIG. 4.

a user or automated process desires to provision a computational system with one or more clusters.

In step 400, the user creates a cluster object.

In step 404, the user or automated process assigns to a selected cluster object a name in field(s) 304. The name can be any identifier for the cluster object that distinguishes it from other cluster objects.

In step 408, the user or automated process assigns a cluster type and/or profile to the selected cluster object in field(s) 304.

In step 412, the user or automated process configures the selected cluster object by configuring attributes and metadata for the cluster in field(s) 308 and 320. The newly created cluster object can be placed in an unassigned pool.

In step 416, the user or automated process adds, in field(s) 312, cluster elements to the selected cluster object. Cluster elements meeting the minimum requirements set forth in the cluster attributes can be added to the cluster. A cluster element can only be assigned to, or have membership in, one cluster. When added, the cluster element uses the cluster attributes to configure and initialize a corresponding data grid so that the grid is ready to install installable software modules, such as snap-ins. Software modules can be installed any time after a minimum number of cluster elements have been added to the cluster object. No software module can be installed on a cluster that would cause a cluster capacity to be exceeded. New cluster elements can be added to the cluster at any time until a maximum allowed size is reached. A cluster element can be removed from a cluster if there are enough cluster elements remaining to meet the minimum number of cluster elements required. Removed cluster elements are placed in an unassigned pool.

In step 420, the user or automated process configures the application attributes for the selected cluster object by populating field 316.

In step 424, the user or automated process sets up the selected cluster and cluster member elements in a network routing policy. Provisioning a set of cluster elements in a cluster configures automatically an (HTTP) load balancer (running on one of the elements with another element as a backup) to distribute traffic among all of the elements in the cluster without requiring a Doman Name Service (“DNS”) to translate domain names to corresponding numerical IP addresses.

In step 428, the automated process configures the selected cluster object and, if no further cluster object is to be provisioned, terminates operation in step 432. The cluster attributes from the cluster profile are added into the master database. This step includes installing optional applications for a closed cluster having optional applications and installing additional applications for an open cluster. The cluster, once configured, is then brought into service.

Clustering offers the ability to manage the capacities of space for logging, memory usage, and CPU usage. The capacities can be engineered by the cluster profile creator and set in the cluster profile attributes. An installable software module can then declare its needs for an allocation of the resources. It no such declaration is made, a default allocation is assigned. Before an installable software module is installed, its allocation needs are checked against the remaining capacities of each resource. If there is not enough capacity remaining, the installation of the installable software module can be blocked or denied. Log files can be rolled to prohibit an installable software module from exceeding its allocation.

The same cluster profile can be applied to more than one cluster. In this event, the different clusters would have different cluster elements but identical cluster attributes (except attributes that are cluster-unique such as cluster name) and installable software modules.

The computational systems discussed herein can run on any processor. Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture.

The exemplary systems and methods of this disclosure have been described in relation to telecommunication systems. However, to avoid unnecessarily obscuring the present disclosure, the preceding description omits a number of known structures and devices. This omission is not to be construed as a limitation of the scopes of the claims. Specific details are set forth to provide an understanding of the present disclosure. It should however be appreciated that the present disclosure may be practiced in a variety of ways beyond the specific detail set forth herein.

Furthermore, while the exemplary aspects, embodiments, and/or configurations illustrated herein show the various components of the system collocated, certain components of the system can be located remotely, at distant portions of a distributed network, such as a LAN and/or the Internet, or within a dedicated system. Thus, it should be appreciated, that the components of the system can be combined in to one or more devices, such as a collection of servers, or collocated on a particular node of a distributed network, such as an analog and/or digital telecommunications network, a packet-switch network, or a circuit-switched network. It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the disclosed embodiments, configuration, and aspects.

A number of variations and modifications of the disclosure can be used. It would be possible to provide for some features of the disclosure without providing others.

For example in one alternative embodiment, the present disclosure can apply to provisioning groups of computational systems or devices other than servers, such as switches, gateways, firewalls, routers, telephones, personal computers, and the like.

In another alternative embodiment, the present disclosure applies to computational environments other than telecommunication systems, such as computer networks.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the disclosed embodiments, configurations and aspects includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the aspects, embodiments, and/or configurations with reference to particular standards and protocols, the aspects, embodiments, and/or configurations are not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various aspects, embodiments, and/or configurations, includes components, methods, processes, systems and/or apparatus substantially as depicted and described herein, including various aspects, embodiments, configurations embodiments, subcombinations, and/or subsets thereof. Those of skill in the art will understand how to make and use the disclosed aspects, embodiments, and/or configurations after understanding the present disclosure. The present disclosure, in various aspects, embodiments, and/or configurations, includes providing devices and processes in the absence of items not depicted and/or described herein or in various aspects, embodiments, and/or configurations hereof, including in the absence of such items as may have been used in previous devices or processes, e.g., for improving performance, achieving ease and\or reducing cost of implementation.

The foregoing discussion has been presented for purposes of illustration and description. The foregoing is not intended to limit the disclosure to the form or forms disclosed herein. In the foregoing Detailed Description for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the description has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A system, comprising:
first and second clusters of servers, the first cluster corresponding to a first set of cluster attributes and the second cluster to a second set of cluster attributes, the first set of cluster attributes defining a common set of attributes for each member server of the first cluster and the second set of cluster attributes defining a common set of attributes for each member server of the second cluster, wherein the first and second sets of cluster attributes are different.

2. The system of claim 1, wherein the system is a general purpose application platform, wherein each first and second cluster runs multiple applications, and wherein identities of applications in a first set of software applications to be run by the member servers of the first cluster and associated configurations of the members of the first set of software applications are in the first set of cluster attributes and identities of applications in a second set of software applications to be run by the member servers of the second cluster and associated configurations of the members of the second set of software applications are in the first set of cluster attributes.

3. The system of claim 1, wherein the attributes in the first and second sets of cluster attributes comprise a plurality of: cluster type and/or version, cluster server minimum version, minimum and/or maximum number of cluster servers, minimum cluster server resource specification, required software applications and/or minimum versions, optional software applications and/or minimum versions, whether the attribute is viewable on an administrator user interface, whether the attribute is editable by an administrator, whether the cluster is open for new software application inclusions or closed to new software application inclusion, data grid type and configuration, load balancer enablement and configuration, disk allocations, memory allocations, open ports, port ranges, and rate limits.

4. The system of claim 2, wherein the first and second sets of software applications comprise one or more of the following applications: enhanced caller ID services, recording services, call blocking services, call routing services, mid-call announcement services, service watchdog, access to components, serviceability agent and netSNMP service, provisioning database service, management agent service, firewall service, operating system, hypervisor service, data grid cluster manager and/or gigaspaces manager, gigaspaces container, container, custom application router, data access API service, logging AP service, eventing framework service, SIP sequenced service, SIP named service, SIP virtual endpoint service, HTTP named application, a proxy application, a Back-to-Back User Agent (B2BUA), a named application service, gateway, context store service, workflow engine, unified speech service, a WebRTC gateway, a work assignment engine, performance center service, presence service, unified agent desktop, and call event/control service.

5. The system of claim 1, wherein the first and second sets of cluster attributes are part, respectively, of first and second cluster definitions, each of the first and second cluster definitions further comprising a plurality of a cluster name, cluster type, server identifiers, and application identifiers.

6. The system of claim 5, wherein the first and second sets of cluster definitions comprise the server identifiers and application identifiers and wherein the server identifiers of the first and second sets of cluster definitions are disjoint sets.

7. The system of claim 6, wherein the application identifiers of the first and second sets of cluster definitions have at least one application identifier in common.

8. A system, comprising:
a processor; and
a tangible and non-transient computer readable medium comprising:
a first set of cluster attributes corresponding to a first cluster of servers and a second set of cluster attributes corresponding to a second cluster of servers, the first set of cluster attributes defining a common set of attributes for each member server of the first cluster and the second set of cluster attributes defining a common set of attributes for each member server of the second cluster, wherein the first and second sets of cluster attributes are different.

9. The system of claim 8, wherein the system is a general purpose application platform, wherein each first and second cluster runs multiple applications, and wherein identities of applications in a first set of software applications to be run by the member servers of the first cluster and associated configurations of the members of the first set of software applications are in the first set of cluster attributes and identities of applications in a second set of software applications to be run by the member servers of the second cluster and associated configurations of the members of the second set of software applications are in the first set of cluster attributes.

10. The system of claim 8, wherein the attributes in the first and second sets of cluster attributes comprise a plurality of: cluster type and/or version, cluster server minimum version, minimum and/or maximum number of cluster servers, minimum cluster server resource specification, required software applications and/or minimum versions, optional software applications and/or minimum versions, whether the attribute is viewable on an administrator user interface, whether the attribute is editable by an administrator, whether the cluster is open for new software application inclusions or closed to new software application inclusion, data grid type and configuration, load balancer enablement and configuration, disk allocations, memory allocations, open ports, port ranges, and rate limits.

11. The system of claim 10, wherein the first and second sets of software applications comprise one or more of the following applications: enhanced caller ID services, recording services, call blocking services, call routing services, mid-call announcement services, service watchdog, access to components, serviceability agent and netSNMP service, provisioning database service, management agent service, firewall service, operating system, hypervisor service, data grid cluster manager and/or gigaspaces manager, gigaspaces container, container, custom application router, data access API service, logging AP service, eventing framework service, SIP sequenced service, SIP named service, SIP virtual endpoint service, HTTP named application, a proxy application, a Back-to-Back User Agent (B2BUA), a named application service, gateway, context store service, workflow engine, unified speech service, a WebRTC gateway, a work assignment engine, performance center service, presence service, unified agent desktop, and call event/control service.

12. The system of claim 8, wherein the first and second sets of cluster attributes are part, respectively, of first and second cluster definitions, each of the first and second cluster definitions further comprising a plurality of a cluster name, cluster type, server identifiers, and application identifiers.

13. The system of claim 12, wherein the first and second sets of cluster definitions comprise the server identifiers and application identifiers and wherein the server identifiers of the first and second sets of cluster profiles are disjoint sets.

14. The system of claim 13, wherein the application identifiers of the first and second sets of cluster definitions are have at least one application identifier in common.

15. A method, comprising:
selecting a first cluster object;
assigning an identifier to the first cluster object;
associating the first cluster object with at least one of a cluster profile type and set of attributes; and
assigning a plurality of servers to the first cluster object to form a first cluster of servers, wherein, when the first cluster profile is compared to a second cluster profile for a second cluster of servers, at least one of the following is true: (i) the attributes of the first cluster is different from the attributes of the second cluster and (ii) the servers in the first and second clusters are disjoint sets.

16. The method of claim 15, wherein (i) is true and wherein the attributes in the first and second sets of cluster attributes comprise a plurality of: cluster type and/or version, cluster server minimum version, minimum and/or maximum number of cluster servers, minimum cluster server resource specification, required software applications and/or minimum versions, optional software applications and/or minimum versions, whether the attribute is viewable on an administrator user interface, whether the attribute is editable by an administrator, whether the cluster is open for new software application inclusions or closed to new software application inclusion, data grid type and configuration, load balancer enablement and configuration, disk allocations, memory allocations, open ports, port ranges, and rate limits.

17. The method of claim 15, wherein (ii) is true and wherein, when a server is associated with the first cluster object, the server uses the first cluster attributes to configure and initialize a corresponding data grid to install one or more software applications specified in the attributes.

18. The method of claim 15, wherein, during provisioning of the servers in the first cluster, a load balancer is configured automatically to distribute traffic among all of the provisioned servers without requiring a domain name service to translate domain names to corresponding IP addresses.

19. The method of claim 15, wherein the first and second clusters are part of a general purpose application platform, wherein each first and second cluster runs multiple applications, and wherein identities of applications in a first set of software applications to be run by the member servers of the first cluster and associated configurations of the members of the first set of software applications are in the first set of cluster attributes and identities of applications in a second set of software applications to be run by the member servers of the second cluster and associated configurations of the members of the second set of software applications are in the first set of cluster attributes.

20. The method of claim 19, wherein the first and second sets of software applications comprise one or more of the following applications: enhanced caller ID services, recording services, call blocking services, call routing services, mid-call announcement services, service watchdog, access to components, serviceability agent and netSNMP service, provisioning database service, management agent service, firewall service, operating system, hypervisor service, data grid cluster manager and/or gigaspaces manager, gigaspaces container, container, custom application router, data access API service, logging AP service, eventing framework service, SIP sequenced service, SIP named service, SIP virtual endpoint service, HTTP named application, a proxy application, a Back-to-Back User Agent (B2BUA), a named application service, gateway, context store service, workflow engine, unified speech service, a WebRTC gateway, a work assignment engine, performance center service, presence service, unified agent desktop, and call event/control service.
